(19) United States
(12) Patent Application Publication
(10) Pub. No.: US 2012/0175434 A1
(43) Pub. Date: Jul. 12, 2012

(54) Anti-Wear Layer Arrangement and Structural Element having an Anti-Wear Layer Arrangement

(75) Inventors: Rainer Feuerfeil, Gerlingen (DE); Ulrich May, Rutesheim (DE); Michael Fraune, Stuttgart (DE)

(73) Assignee: Robert Bosch GmbH, Stuttgart (DE)

(21) Appl. No.: 13/321,068

(22) PCT Filed: Mar. 22, 2010
(86) PCT No.: PCT/EP2010/053701

§ 371 Date: Mar. 24, 2012

(30) Foreign Application Priority Data
May 18, 2009 (DE) 102009003192.8

(51) Int. Cl. F02M 63/00; B32B 5/00; B32B 15/04

(52) U.S. Cl. 239/533.2; 428/336; 428/688; 428/457

(57) ABSTRACT

An anti-wear layer arrangement, in particular for components of a fuel injection system that are subjected to high pressures and high temperatures. The anti-wear layer arrangement has a protective layer formed from tetragonally bonded amorphous carbon or having a proportion of tetragonally bonded amorphous carbon, and also an adhesion promoter layer having titanium between the structural element and the protective layer. The adhesion promoter layer contains at least one oxidation-resistant element in addition to titanium.

### PRIOR ART

The invention relates to an anti-wear layer arrangement, in particular for components of a fuel injection system that are subjected to high pressures and temperatures, according to the preamble of claim 1 and to a structural element according to claim 7.

The applicant uses a metal-free, amorphous, hydrogen-containing carbon layer (a-C:H layer) as an anti-wear layer as standard for structural elements in injection technology to reduce friction and wear. The thickness of the carbon layer applied to the surface of the structural element by processes involving plasma technology is in this case typically between 1 μm and 3 μm.

Also used on structural components are tetragonally amorphous, hydrogen-free carbon layers (ta-C layers), which are distinguished by improved properties in comparison with the a-C:H layers. To be able to apply the ta-C layer to the structural element in a firmly adhering manner, the ta-C layer is provided as a constituent of an anti-wear layer arrangement, which comprises in addition to the ta-C layer an adhesion promoter layer of titanium deposited by a plasma-enhanced process. Particularly in view of the increasingly rising pressures and temperatures in injection technology, there are efforts to improve the adhesive strength of ta-C layers on surfaces of structural elements.

### DISCLOSURE OF THE INVENTION

The invention achieves the effect of developing an anti-wear layer arrangement in such a way that it has a greater adhesiveness at relatively high temperatures under inert or oxidizing gas atmospheres. The invention is thereby based on the idea of additionally adding to the adhesion promoter layer consisting of titanium an element of an oxidation-resistant element. This constituent has the effect of reducing the high chemical reactivity of titanium or increasing the oxidation resistance of the adhesion promoter layer, and consequently altogether increasing the adhesiveness of the protective layer arrangement.

Advantageous developments of the anti-wear layer arrangement according to the invention, in particular for structural elements of a fuel injection system that are subjected to high pressures and high temperatures, are specified in the subclaims and the description which follows.

It has been found to be advantageous if the element is at least one element from the group of elements niobium, chromium, vanadium, silicon, nickel, praseodymium, molybdenum or tantalum.

It is particularly advantageous in this respect if the proportion of the at least one oxidation-resistant element is between 1% and 40% of the adhesion promoter layer.

It is particularly preferred to apply the adhesion promoter layer by means of a PVD process (physical vapor phase deposition) directly to the surface of the first component to be coated, preferably at least in the region to be coated, consisting of steel.

Ideally, the protective layer itself is also applied by means of a PVD process, preferably under a vacuum.

Good results with regard to optimized adhesive strength of the anti-wear layer arrangement are achieved if the adhesion promoter layer has a layer thickness from a range of values between approximately 50 nm and approximately 300 nm. It is particularly preferred for the total thickness of the anti-wear layer arrangement to be chosen from a range of values between approximately 1 μm and 10 μm.

The invention also leads to a structural element, in particular of a fuel injection system. It is most particularly preferred for the structural element to consist of steel, at least in the region to be coated. The structural element is distinguished by an anti-wear layer arrangement described above, formed according to the concept of the invention. It is most particularly preferred for the structural element to be a component part of a fuel injector, in particular a nozzle needle. Similarly, the structural element may be a component part of a high-pressure fuel pump.

Further advantages, features and details of the invention emerge from the following description of preferred exemplary embodiments and from the drawings, in which:

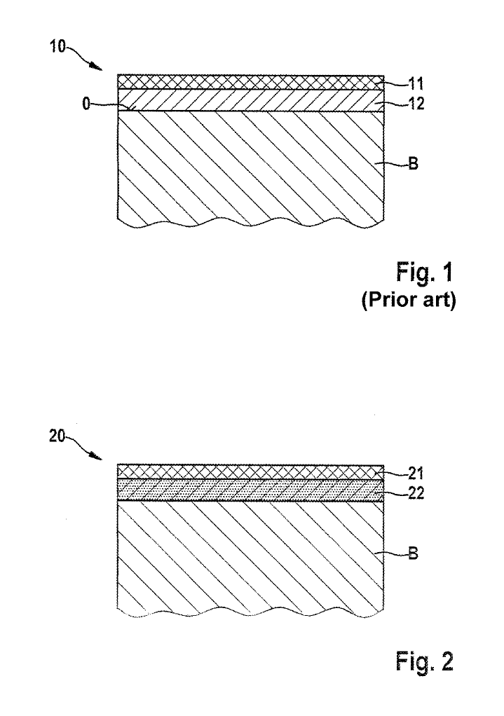

FIG. 1 shows a schematic layer structure by means of an adhesion promoter layer according to the prior art, and

FIG. 2 shows an anti-wear layer arrangement according to the invention, likewise in a schematic view.

In FIG. 1, an anti-wear layer arrangement 10 according to the prior art is illustrated. The anti-wear layer arrangement 10 comprises a protective layer 11, which contains tetragonally bonded amorphous carbon, or a proportion of tetragonally bonded amorphous carbon. With an adhesion promoter layer 12 interposed, the protective layer 11 is arranged on a component B. The adhesion promoter layer 12 consists of pure titanium and has a layer thickness of about 40 nm to 100 nm. By contrast, the layer thickness of the protective layer 11 is between 2 μm and 5 μm. The adhesion promoter layer 12 is applied directly on the surface O of the component B.

In FIG. 2, an anti-wear layer arrangement 20 according to the invention is represented. The anti-wear layer arrangement 20 includes a protective layer 21, which may be of a structure identical to the protective layer 11 in the case of the anti-wear layer arrangement 10, i.e. consists in particular of tetragonally bonded amorphous carbon, or contains proportions of tetragonally bonded amorphous carbon. With an adhesion promoter layer 22 interposed, the protective layer 21 is applied on the component B directly, on the surface O thereof.

According to the invention, the adhesion promoter layer 22 consists of titanium and additionally of an oxidation-resistant element. The oxidation-resistant element is preferably at least one element from the group of elements niobium, chromium, vanadium, silicon, nickel, praseodymium, molybdenum or tantalum. With particular preference, it is one of the elements silicon or niobium or a combination of the elements silicon and niobium. The proportion of the at least one oxidation-resistant element in the overall adhesion promoter layer 22 is between 1% and 40%, preferably between 10% and 20%. The adhesion promoter layer 22 is applied to the surface O of the component B by means of a PVD process.

After the application of the adhesion promoter layer 22, the protective layer 21 is applied to the adhesion promoter layer 22, preferably likewise by the PVD process, in particular under a vacuum. Here, the total thickness of the anti-wear layer arrangement 20 consisting of the protective layer 21 and the adhesion promoter layer 22 is between approximately 1 μm and 10 μm. The component B is, in particular, a component B of a fuel injection system, which preferably consists of steel, at least in the region of the component B that is to be coated. Here, the component B is, in particular, a component part of a fuel injector, in particular a nozzle needle, or a component part of a high-pressure fuel pump.

1. An anti-wear layer arrangement, in particular for structural elements of a fuel injection system that are subjected to high pressures and high temperatures, comprising:
a protective layer formed from tetragonally bonded amorphous carbon or comprising a proportion of tetragonally bonded amorphous carbon, and
an adhesion promoter layer, comprising titanium, between the structural element and the protective layer,
wherein the adhesion promoter layer further comprises at least one oxidation-resistant element.

2. The anti-wear layer arrangement as claimed in claim 1, wherein the at least one oxidation-resistant element is an element selected from the group of elements niobium, chromium, vanadium, silicon, nickel, praseodymium, molybdenum and tantalum.

3. The anti-wear device as claimed in claim 1, wherein the proportion of the at least one oxidation-resistant element is between 1% and 40%.

4. The anti-wear layer arrangement as claimed in claim 1, wherein the adhesion promoter layer is applied to the component by a PVD process.

5. The anti-wear layer arrangement as claimed in claim 1, wherein the protective layer is applied to the adhesion promoter layer by a vacuum PVD process.

6. The anti-wear layer arrangement as claimed in claim 4, wherein the adhesion promoter layer has a layer thickness of 50 nm to 300 nm.

7. The anti-wear layer arrangement as claimed in claim 1, wherein the total thickness of the anti-wear layer arrangement is chosen from a range of values between approximately 1 μm and 10 μm.

8. A fuel injection system including a structural element, with an anti-wear layer arrangement that includes:
a protective layer formed from tetragonally bonded amorphous carbon or comprising a proportion of tetragonally bonded amorphous carbon, and
an adhesion promoter layer, comprising titanium, between the structural element and the protective layer,
wherein the adhesion promoter layer further comprises at least one oxidation-resistant element.

9. The fuel injection system as claimed in claim 8, wherein the structural element is a nozzle needle.

10. The anti-wear device as claimed in claim 3, wherein the proportion of the at least one oxidation-resistant element is between 10% and 20%.

11. The fuel injection system as claimed in claim 8, wherein the structural element is made of steel.

12. The fuel injection system as claimed in claim 8, wherein the structural element is a component part of a high-pressure fuel pump.
